(19) United States
(12) Patent Application Publication
(10) Pub. No.: US 2006/0040670 A1
(43) Pub. Date: Feb. 23, 2006

(54) Method for routing a connection from a first mobile station to a second mobile station, wireless communication system, central routing device, and mobile station

(76) Inventors: Hui Li, Munchen (DE); Egon Schulz, MUNICH (DE); Dan Yu, MUNICH (DE)

Correspondence Address: STAAS & HALSEY LLP, SUITE 700, 1201 NEW YORK AVENUE, N.W., WASHINGTON, DC, 20005, US

(21) Appl. No.: 10/527,187

(22) PCT Filed: Aug. 6, 2003
(86) PCT No.: PCT/EP03/08714

§ 371 Date: Mar. 10, 2005

(30) Foreign Application Priority Data
Sep. 13, 2002 (EP) 020647.0

(51) Int. Cl. H04Q 7/20

(52) U.S. Cl. 455/445; 455/425

(57) ABSTRACT

Disclosed is a method in which a connection is routed from a first mobile station to a second mobile station via at least one additional mobile station, pieces of positional information being detected via the mobile stations. A central routing device determines a route for the connection based on the pieces of positional information. The routing device generates routing information corresponding to the determined route and transmits said routing information to the mobile stations.

### CROSS REFERENCE TO RELATED APPLICATIONS

This application is based on and hereby claims priority to PCT Application No. PCT/EP2003/008714, filed Aug. 6, 2003 and European Application No. 02020647.0 filed Sep. 13, 2002, the contents of which are hereby incorporated by reference.

### BACKGROUND OF THE INVENTION

The invention relates to a method for routing a connection from a first mobile station to a second mobile station by way of at least one further mobile station in a wireless communication system, and also a corresponding wireless communication system and a central routing device, and also a mobile station for a wireless communication system.

In the field of mobile wireless communication, cellular mobile wireless networks are known in which the individual wireless cells are supplied by a base station in each case. Known standards for cellular mobile wireless networks are for example GSM (Global System of Mobile Communication) and UMTS (Universal Mobile Telecommunications Standard). If a connection is to be established in such a cellular mobile wireless system from one mobile user to another mobile user, an appropriate route through the network connected to the base stations is determined. This is done as a rule by a central unit in the mobile wireless network. The route determined begins at one of the participating mobile stations as the start mobile station and passes initially to the base station of the particular wireless cell in which the start mobile station is located. From this first base station the data for the connection is then either transmitted directly to the destination mobile station (insofar as the latter is likewise located in the same wireless cell) or it is transmitted to a second base station in whose wireless cell the destination mobile station is located and which then transmits the data for the connection to the destination mobile station.

Moreover, within the framework of mobile wireless communication so-called self-organizing networks or ad-hoc networks are known which are formed simply by mobile stations without any use being made of base stations with their wireless cells. With regard to these ad-hoc networks, the mobile stations assume a relay function with the result that data for a connection is forwarded from a start mobile station to a destination mobile station directly by way of one or more other mobile stations. The routing in an ad-hoc network is carried out according to certain algorithms by the participating mobile stations themselves. To this end, the start mobile station for example sends an address of the destination mobile station to all the mobile stations surrounding it in order to signal its connection request. This signaling information is passed on by the surrounding mobile stations until it reaches the destination station. The addresses of the neighboring mobile stations on the determined route are stored in the participating mobile stations in each case for the route which is ultimately successfully established.

Furthermore, mobile wireless systems are known in which in the case of a cellular network structure mobile stations are used which are also capable of communicating directly with one another in the manner of an ad-hoc network. In this manner, for example, gaps can be closed between the individual wireless cells of the cellular network across a plurality of mobile stations as relay stations. Such types of cellular mobile wireless networks with an ad-hoc component are described for example in Y.-D. Lin et. al. “Multihop Cellular: A new architecture for wireless communications”, IEEE INFOCOM 2000, pp. 1273 to 1282, H.WU et. al. “Integrated cellular and ad-hoc relaying systems: iCAR”, IEEE Journal on selected areas in communications, Vol. 19, No. 10, October 2001, pp. 2105 to 2115; R. Ananthapadmanabha et. al. “Multihop Cellular Networks: the architecture and routing protocols”, IEEE PIMRC 2001 and also in the concept of Group Delta for the Wideband TDMA/CDMA UMTS Standard, ETSI SMG2#24 Tdoc SMG 899/97, Madrid, Spain, 15-19 Dec. 1997.

With regard to the aforementioned cellular mobile wireless networks in which mobile stations having a relay function are also provided, the routing from mobile station to mobile station takes place in the normal manner described above of an ad-hoc network. That part of a connection which is conducted by way of the base stations in the network is however routed as in the case of a known cellular mobile wireless network, in other words through a generally central routing device in the network.

### SUMMARY OF THE INVENTION

One possible object of the invention is to implement the routing of a connection from a first mobile station to a second mobile station by way of at least one further mobile station, such as is necessary for example in an ad-hoc network, in an advantageous manner.

With regard to the method for routing a connection from a first mobile station to a second mobile station by way of one or more further mobile stations, positional information is initially acquired by way of the mobile stations. A central routing device then determines a route for the connection based on the acquired positional information and generates corresponding routing information which is afterwards transmitted to the mobile stations participating in the connection.

The mobile stations communicate directly with one another. The further mobile stations therefore have a relay function for the data of the connection to be transmitted from the first mobile station to the second mobile station.

Positional information comprises information about the geographical position of the mobile stations which is suitable for defining the mutual arrangement of the mobile stations in the wireless communication system such that the routing can be performed on the basis of this positional information. With regard to the positional information, this can for example be position coordinates determined by a position determination system such as GPS for example.

Whereas in routing methods for ad-hoc networks the routing is carried out by the participating mobile stations themselves, the method and devices described herein may provide a special routing device for this purpose. The central routing device can take into consideration the positional information acquired from a large number of mobile stations during routing. In an extreme case this can affect all available mobile stations. In this manner, an optimum route can be determined in a simple manner.

The execution of routing by the central routing device enables a reduction in power consumption for mobile stations and a reduction in the signals exchanged between the mobile stations when compared with the execution of routing by the mobile stations themselves, as is the case with the related art.

“Mobile station” here is understood to be any mobile wireless station which is provided for use in a wireless communication system and which is capable of maintaining direct communication with another mobile station.

The mobile stations are located in wireless range of at least one base station of a cellular mobile wireless network. The routing device then transmits the routing information to the base stations which perform onward transmission of the routing information to the mobile stations. This means that the mobile stations are operated with a relay function in the coverage area of the cellular mobile wireless network. In this respect there are similarities with the concepts described above in which mobile stations having a relay function are also operated in conjunction with cellular networks. In contrast to the latter though, also the routing for the direct relay connections between the mobile stations is also not performed by the mobile stations themselves but by the central routing device connected to the base stations of the cellular mobile wireless network.

The method and devices described herein may make it possible for the connection between the first mobile station and the second mobile station to be simply a section of a longer connection between further mobile stations. In such a case, taking a start mobile station as the basis, a partial connection can initially be established for example by way of one or more base stations in the cellular network to the first mobile station and/or from the second mobile station by way of one or more base stations a further partial connection to the destination station of the overall connection. The connection between the first and the second mobile station is then simply a partial connection of the overall connection between start station and destination station.

According to a development, the mobile stations determine their positional information themselves and transmit it for acquisition purposes to the base stations. The base stations can then advantageously transmit the positional information to a central storage device which the routing device can access in order to determine the route.

According to a development, the mobile stations have a first operating mode in which they are operated in the cellular mobile wireless network in accordance with a first wireless standard. This first wireless standard can be any desired standard for a cellular mobile wireless network such as GSM or UMTS for example. In this development, the mobile stations have a second operating mode in which they form an ad-hoc network with one another in accordance with a second wireless standard. These are therefore referred to as so-called dual-mode mobile stations. During the connection for which the routing device determines the routing information the mobile stations are operated in the second operating mode. In this situation, an ad-hoc network is understood to be a mobile wireless network in which the individual mobile stations exercise relay functions for the transmission of data for a connection. In the first and second operating modes, provision can be made in accordance with the first and second wireless standard respectively for the mobile stations to communicate with one another in different frequency ranges in each case in accordance with different protocols. The wireless communication system then relates to two superimposed networks, namely the cellular network and the ad-hoc network.

According to a development, the mobile stations are only placed in the second operating mode when the cellular mobile wireless network reaches a limit value for its capacity loading. With regard to this development, the use of the relay function of the mobile stations serves simply to increase the overall capacity of the wireless communication system, insofar as this is necessary. If this is not required, it is possible to dispense with the determination of the routes by the central routing device on the basis of the acquired positional information and with the transmission of the corresponding routing information to the mobile stations, and instead the routing can take place as normally occurs in known cellular mobile wireless systems. The resource requirement for determining the route is kept small while the limit value for the capacity loading remains unexceeded. It is however also advantageous if the routing device handles the routing both for the ad-hoc network and also for the cellular network.

According to a development, the second mobile station makes available a particular service. Service information concerning the service made available by the second mobile station is stored in a storage device, which information is communicated to the first mobile station. On the basis of the service information notified to it, the first mobile station then signals to the routing device that it should access the service. The routing device then establishes the connection from the first mobile station to the second mobile station by generating the corresponding routing information. Service here is understood to comprise any desired service within a mobile wireless network to which a mobile station is able to offer access. With regard to such a service, it can for example be a case of a location dependent service which makes available for example information about restaurants or cinemas situated in the vicinity depending on the position of a mobile station. A further service is for example the provision of access to the internet or to other networks.

According to a development, the base stations broadcast the service information stored in the storage device (broadcasting). Service information concerning services made available by a large number of mobile stations can be stored in the storage device and be notified to the other mobile stations by broadcasting from the base stations. Any mobile station is then able to request a connection to the desired service from the central routing device. Since the position of any mobile station situated in the mobile wireless system can be acquired, the routing device also has a knowledge of the position of the mobile station offering the service in question. On receiving a request for the corresponding service, it can therefore establish a connection to the mobile station offering this service.

According to a development, the routing information contains details concerning the transmit power level with which the mobile stations participating in the connection are to operate the connection. Since the routing device has a knowledge of the position of the participating mobile stations, it also knows the distances between the mobile stations and can therefore calculate the transmit power required for the transmission to the next mobile station within the route. In this manner, it is possible to minimize the transmit power required overall in the system and interference effects are reduced to a minimum.

According to a development, the routing information contains details concerning which transmission resources the mobile stations participating in the connection are to reserve for the connection. “Transmission resources” here is understood to include all the wireless resources required for the transmission, for example frequency ranges in the case of an FDMA system, spread codes in the case of a CDMA system and time slots in the case of a TDMA system.

According to a development, on termination of the connection the routing device instructs the mobile stations participating in the connection to terminate the reservation of the transmission resources for this connection. In this manner, the previously reserved transmission resources are available once again for the establishment of new connections.

The wireless communication system and also the central routing device and the mobile station for a wireless communication system comprise the components needed to implement the method and are designed in a corresponding manner.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an embodiment of the wireless communication system according to one potential embodiment of the invention, and

FIG. 2 shows an embodiment of a mobile station for the wireless communication system shown in FIG. 1.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

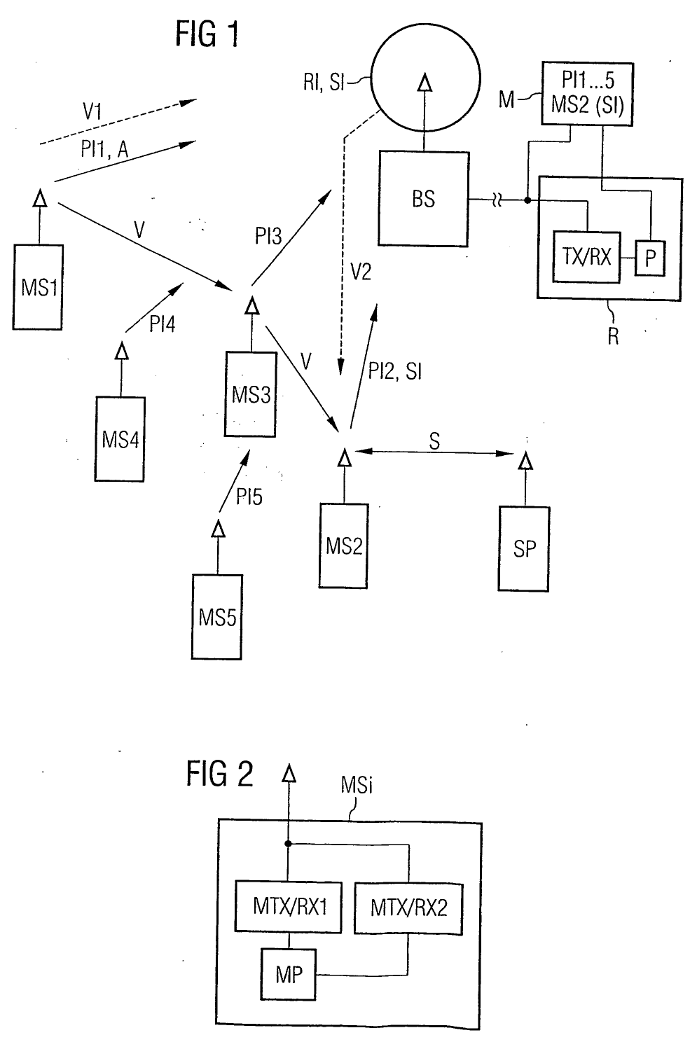

FIG. 1 shows a section of a wireless cell of a cellular mobile wireless system. This depicts a base station BS which supplies the wireless cell, and also a series of mobile stations MS1 to MS5 which are located in the wireless cell. The second mobile station MS2 maintains a wireless connection with a service provider SP. The service provider SP offers any desired service, access to the internet for example. The second mobile station MS2 can make available the service or services offered by the service provider SP to other users of the mobile wireless system by way of the connection S. The second mobile wireless station MS2 communicates service information SI to the base station BS, which describes the service made available and is stored by the base station BS in a central storage device M in the mobile wireless system in relation to an identifier of the second mobile station MS2.

All mobile stations MS1 to MS5 currently operating in the mobile wireless system periodically send positional information PI1 to PI5 to the base station BS which stores this information similarly in relation to the respective mobile station in the central storage device M. The positional information PI1 to PI5 describes the geographical position of the respective mobile station MS1 to MS5 in the relevant wireless cell of the mobile wireless system.

The positional information PI1 to PI5 is determined by the mobile stations MS1 to MS5 by GPS receivers. With regard to other embodiments, the positional information PI1 to PI5 can also be determined by the base stations BS in the mobile wireless system instead of by the mobile stations MS1 to MS5. Methods for determining the position of a mobile station in a cellular mobile wireless system are adequately known to the person skilled in the art and will not be described further here.

All base stations BS in the mobile wireless system transmit the service information SI stored in the central storage device M by broadcasting. As a result, the service information SI is made accessible to all mobile stations MS1 to MS5. The service information SI provides information in this manner to the mobile stations MS1 to MS5 about which special services are available in the mobile wireless system.

The first mobile station MS1 in FIG. 1 decides on the basis of the service information SI sent out by the base station BS that it wishes to access the service signaled by the latter. It conveys a corresponding connection request A to the base station BS for its wireless cell.

In addition, the mobile wireless system in FIG. 1 has a central routing device R with a transmit/receive facility TX/RX for communicating with the base stations BS of the mobile wireless system and also a processor P for controlling it. The base station BS conveys the connection request A made by the first mobile station MS1 to the routing device R. The routing device R accesses the positional information PI1 to PI5, stored in the storage device M, for all the mobile stations MS1 to MS5 acquired in the mobile wireless system. In addition, on the basis of the entry in the storage device M the routing device R ascertains that the second mobile station MS2 is offering the service required by the first mobile station MS1. The routing device R then calculates a route, optimized to the greatest possible extent, for a connection V between the first mobile station MS1 and the second mobile station MS2. In the case illustrated in FIG. 1 this connection V passes from the first mobile station MS1 by way of the third mobile station MS3 to the second mobile station MS2. Other cases are naturally also conceivable in which more than one mobile station MS3 is defined as a relay station for establishing the connection V. When selecting the route used for the connection V, the routing device R considers the geographical position of the mobile stations and attempts to implement a path which is as short as possible in order to minimize the transmit power needed for the connection V. In addition, the routing device R considers to what extent resources of the mobile stations MS1-MS5 in the form of frequency ranges, spread codes or time slots have already been reserved by other connections.

The routing device R in FIG. 1 generates routing information RI, corresponding to the route it has determined, which it transmits to the base station BS for those wireless cells in which the mobile stations MS1, MS2, MS3 participating in the connection V are situated. The base station BS broadcasts this routing information RI such that it can be received by the mobile stations MS1 to MS3 concerned. The routing information RI notifies the mobile stations MS1 to MS3 about the mobile station MSi from which they are to receive data relating to the connection V for onward transmission as a relay station and to which mobile station MSi they are to forward this data. For the first mobile station MS1 there is no preceding station in the route for the connection V because it is the start station. It is therefore only notified of the fact that it should transmit its data to the third mobile station MS3. The routing information RI for the third mobile station MS3 tells the latter that it is to receive data from the first mobile station MS1 and forward it to the second mobile station MS2. The second mobile station MS2 learns by way of the routing information RI that it is to receive transmissions from the third mobile station MS3 for the connection V. Since the second mobile station MS2 is the destination station for the connection V, it is not notified by way of the routing information RI of any further mobile station MSi to which it should forward the data.

The method described above for routing the connection V through the routing device R can naturally also be executed independent of the request for a special service by the first mobile station MS1. On the basis of the positional information PI1 to PI5 for each mobile station MS1 to MS5, which is stored in the storage device M, the routing device R can likewise execute the method described above as a result of a connection request A for a voice connection from the first mobile station MS1 to the second mobile station MS2, for example

FIG. 2 shows the structure of the mobile stations MSi from FIG. 1. These contain a first transmit/receive device MTX/RX1 connected to their antenna for communicating with the base station BS and also a control device MP, connected to the transmit/receive device MTX/RX, which serves in particular to evaluate the routing information RI and service information Si received from the base station BS. The control device MP then controls the mobile station MSi such that it transmits data which is to be transmitted for the connection V in accordance with the received routing information RI to the next relay station determined by the routing device R for the connection V. Depending on the routing information RI, this data can actually be supplied from a further mobile station for which the current mobile station MSi in turn acts as a relay station.

With regard to the mobile wireless system represented in FIG. 1, this is as it were a cellular mobile wireless network having locally superimposed on it an ad-hoc network which is formed by the mobile stations MS1 to MS5 as mobile nodes. In addition to the first transmit/receive device MTX/RX1 for communicating in accordance with the first wireless standard with the cellular mobile wireless network of the mobile wireless system, the mobile station MSi in FIG. 2 therefore also has a second transmit/receive device MTX/RX2 for communicating with the other mobile stations in accordance with the second standard for the ad-hoc network of the mobile wireless system.

The ad-hoc network functions in accordance with the IEEE 802.11 WLAN (wireless local area network) standard.

With regard to the embodiment considered here, the mobile stations MS1 to MS5 each have a directional antenna for communicating with one another. The routing information RI for each of the mobile stations MS1 to MS3 participating in the connection therefore also contains information about the direction in which the data for the connection V is to be transmitted by the respective station to the next relay station by its directional antenna or the direction from which it is to receive the data transmitted to it. In addition, for each of the mobile stations MS1 to MS3 participating in the connection V the routing information RI contains a value for the transmit power to be used whose value is selected depending on the distance between the individual mobile stations communicating with one another. The routing information RI furthermore contains the instruction as to which transmission or wireless resources (frequency range, spread code and time slot in the case of an FD/CD/TDMA multiple access method) are to be used or reserved by the individual mobile station MS1 to MS3 for the connection V. When the connection V is terminated, the mobile stations MS1 to MS3 participating in the connection V are also informed by way of the routing information RI that the transmission resources reserved for the connection V are now to be released again for other connections. In order to implement resource control for the individual mobile stations MS1 to MSS through the central routing device R of the mobile wireless system as described it is necessary for the routing device to be kept constantly informed of the current resource reservation status for each individual mobile station. It therefore has the storage facilities required for this purpose (not shown in FIG. 1).

As an alternative to FIG. 1, instead of being broadcast the transmission of the routing information RI and/or of the service information SI by the base stations BS of the mobile wireless system can also take place by a point-to-point transmission to the respective mobile station MSi. To this end, the base station BS can also be equipped with directional antennas, for example. As a result of the positional information PI1 to PI5 concerning the mobile stations MSi stored in the storage device M, it is easily possible to appropriately orient such types of directional antennas in order to transmit the desired data to certain mobile stations.

The mobile stations MS1-MS5 shown in FIG. 1 are so-called dual-mode devices which can be operated in a first operating mode in accordance with a first wireless standard for a cellular mobile wireless network and in a second operating mode in accordance with a second wireless standard for an ad-hoc network. The first wireless standard can be any desired standard for a cellular mobile wireless network, the GSM standard for example. As long as the transmission capacity of the base stations BS of the mobile wireless system is not fully utilized, connections are preferably established in accordance with the first wireless standard. This is shown in FIG. 1 by the dash-lined arrows V1, V2. As long as the capacity limit of the system for the transmission according to the first wireless standard is not reached, a connection is routed between the first mobile station MS1 and the second mobile station MS2 by way of the base station BS. If the second mobile station MS2 is located (differently to what is shown in FIG. 1) in a different wireless cell from the first mobile station MS1, the connection V1, V2 is also routed by way of a plurality of base stations BS if necessary. Only after the chosen capacity limit for the transmission of connections according to the first wireless standard is exceeded are further connections V according to the second wireless standard established in the manner described above. In this situation, different frequency ranges and different transmission protocols are provided for operation in accordance with the first and the second wireless standards in respect of the embodiment shown in FIG. 1. It is therefore essentially a case of a known cellular mobile wireless system according to the first wireless standard with an almost completely independent ad-hoc network according to the second wireless standard superimposed on it.

A dependence between the two networks exists simply in respect of the routing of all connections V1, V2, V by the central routing device R of the mobile wireless system.

The capacity of the overall mobile wireless system can therefore be increased by establishing new connections V in accordance with the second wireless standard because the transmission capacities or transmission resources of the cellular mobile wireless network are largely independent of the transmission resources of the ad-hoc network.

Thanks to the central routing device R, it is possible to perform routing for connections V within the ad-hoc network without there being any need within the mobile stations MS1 to MS5 to execute the complicated algorithms for routing a connection which are otherwise necessary in the case of ad-hoc networks. In this manner, the computational effort and the high power consumption associated with this within the mobile stations can be reduced.

Apart from the power consumption of the individual mobile stations, as a result of routing being performed by the central routing device the data exchange between the individual mobile stations required for the routing normally performed in an ad-hoc network is also reduced, which means that the workload on the communication system can be reduced.

With regard to the embodiment according to FIG. 1, all mobile stations which make available particular services transmit corresponding service information SI to the respective base station S. This is done periodically in order that the service information SI stored in the storage device M as well as the positional information RI are in each case updated.

With regard to the embodiment considered here, the mobile stations MSi must convert the route determined by the routing device R for the connection V in accordance with the routing information RI supplied to them. Other embodiments are also possible, however, in which the routing information RI serves only as a proposal to the mobile stations MSi. In particular, it is possible for a plurality of such types of proposals to be determined by the routing device R and conveyed to the mobile stations MS1-MS3 for the respective connection V to be established. The mobile stations can then decide for themselves which route is actually to be implemented. With regard to other embodiments, it is also possible for a connection both over the cellular mobile wireless network (in other words involving the participation of at least one of the base stations BS) and also over the ad-hoc network (in other words with the aid of relay stations) to be offered as a choice by way of the routing information RI. The selection of the offered route is usefully made by the first mobile station MS1 acting as the start station for the connection V.

On account of the constant updating of the positional information PI1 to PI5 stored in the storage device M the routing device R can constantly check whether the existing connection V is still being operated optimally with the chosen route. Thus it is also possible in the case of an already existing connection V that a previously chosen route can be discarded and the connection V established using a new route which is notified to the corresponding mobile stations by way of the routing information RI. Advantageously, security related information such as identification information for the users and authentication information for example and also encryption codes are transmitted over the more secure cellular mobile wireless network and only less security related data is transmitted over the ad-hoc network.

In the case where alternative routes are offered, one of which passes over the cellular mobile wireless network and one within the ad-hoc network, a user or a mobile station MSi can advantageously make the selection dependent on the different costs for operating a connection in the two networks. In the case considered here in which the ad-hoc network is operating in accordance with IEEE 802.11 standard, the frequencies to be used for this purpose are situated in the unlicensed area of the wireless spectrum. The operator of the mobile wireless system can therefore offer more favorable rates for connections within the ad-hoc network than for connections within the cellular mobile wireless network which uses a frequency range for which license charges are normally payable to a state-run supervisory authority.

The invention has been described in detail with particular reference to preferred embodiments thereof and examples, but it will be understood that variations and modifications can be effected within the spirit and scope of the invention covered by the claims which may include the phrase “at least one of A, B and C” or a similar phrase as an alternative expression that means one or more of A, B and C may be used, contrary to the holding in Superguide v. DIRECTV, 69 USPQ2d 1865 (Fed. Cir. 2004).

1-13. (canceled)

14. A method for routing a connection from a first mobile station to a second mobile station by way of at least one further mobile station in a wireless communication system, comprising:
acquiring positional information on the first mobile station, the second mobile station and the further mobile station;
determining a route for the connection at a central routing device based on the positional information;
generating routing information at the routing device corresponding to the determined route; and
transmitting the routing information from the routing device to the first mobile station, the second mobile station and the further mobile station.

15. The method according to claim 14, wherein
the wireless communication system operates in conjunction with a cellular mobile wireless network having base stations,
the first, second and further mobile stations are located in wireless range of at least one base station of the cellular mobile wireless network,
the routing device transmits the routing information to the at least one base station, and
the at least one base station transmits the routing information to the first, second and further mobile stations.

16. The method according to claim 15, wherein
the mobile stations determine the positional information and transmit the routing information to the at least one base station.

17. The method according to claim 15, wherein
the mobile stations have a first operating mode in which they operate in the cellular mobile wireless network in accordance with a first wireless standard,
the mobile stations have a second operating mode in which they form an ad-hoc network with one another in accordance with a second wireless standard, and
during the connection for which the routing device determines the routing information, the mobile stations operate in the second operating mode.

18. The method according to claim 17, wherein
the mobile stations operate in the second operating mode only when the cellular mobile wireless network reaches a capacity limit.

19. The method according to claim 14, wherein
the second mobile station makes available a particular service,
service information concerning the service is stored in a storage device,
the service information is provided from the storage device to the first mobile station,
after the first mobile station receives the service information, the first mobile station signals to the routing device that the first mobile station would like to access the service, and
after being signaled by the first mobile station, the routing device establishes a service connection for the service from the first mobile station to the second mobile station by generating routing information for the service connection.

20. The method according to claim 19, wherein
the wireless communication system operates in conjunction with a cellular mobile wireless network having base stations,
the first, second and further mobile stations are located in wireless range of at least one base station of the cellular mobile wireless network,
the at least one base station broadcasts the service information stored in the storage device.

21. The method according to claim 14, wherein
the routing information describes a transmit power level with which the first, second and further mobile stations are to operate for the connection.

22. The method according to claim 14, wherein
the routing information describes transmission resources which the first, second and further mobile stations are to reserve for the connection.

23. The method according to claim 22, wherein
when the connection is to be terminated, the routing device instructs the first, second and further mobile stations to free the transmission resources used for the connection.

24. The method according to claim 16, wherein
the mobile stations have a first operating mode in which they operate in the cellular mobile wireless network in accordance with a first wireless standard,
the mobile stations have a second operating mode in which they form an ad-hoc network with one another in accordance with a second wireless standard, and
during the connection for which the routing device determines the routing information, the mobile stations operate in the second operating mode.

25. The method according to claim 24, wherein
the mobile stations operate in the second operating mode only when the cellular mobile wireless network reaches a capacity limit.

26. The method according to claim 25, wherein
the second mobile station makes available a particular service,
service information concerning the service is stored in a storage device,
the service information is provided from the storage device to the first mobile station,
after the first mobile station receives the service information, the first mobile station signals to the routing device that the first mobile station would like to access the service, and
after being signaled by the first mobile station, the routing device establishes a service connection for the service from the first mobile station to the second mobile station by generating routing information for the service connection.

27. The method according to claim 26, wherein
the at least one base station broadcasts the service information stored in the storage device.

28. The method according to claim 27, wherein
the routing information describes a transmit power level with which the first, second and further mobile stations are to operate for the connection.

29. The method according to claim 28, wherein
the routing information describes transmission resources which the first, second and further mobile stations are to reserve for the connection.

30. The method according to claim 29, wherein
when the connection is to be terminated, the routing device instructs the first, second and further mobile stations to free the transmission resources used for the connection.

31. A wireless communication system, comprising:
a first mobile station, a second mobile station and at least one further mobile station;
a storage device to store positional information regarding the first mobile station, the second mobile station and the further mobile station;
a central routing device to determine a route for a connection between the first mobile station and the second mobile station via the further mobile station and to generate routing information for the route, the route being determined based on the positional information stored in the storage device; and
a transmit unit provided in the routing device to transmit the routing information to the first mobile station, the second mobile station and the further mobile station.

32. A central routing device for a wireless communication system, comprising:
a route generating unit to generate a route for a connection between a first mobile station and a second mobile station by way of at least one further mobile station using positional information for the first mobile station, the second mobile station and the further mobile station; and
a transmit unit to transmit routing information corresponding to the route, to the first mobile station, the second mobile station and the further mobile station.

33. A mobile station for a wireless communication system, comprising:
a receiver to receive and evaluate connection routing information generated by a central routing device based on positional information for the mobile station, a first mobile unit and a second mobile unit; and
a transmitter to transmit data received from the first mobile unit to the second mobile unit according to the connection routing information, to thereby establish a connection between the first and second mobile units.
